(19) United States
(12) Patent Application Publication
(10) Pub. No.: US 2008/0150756 A1
(43) Pub. Date: Jun. 26, 2008

(54) Distance warning device for vehicle

(76) Inventor: Rober Lo, Taichung (TW)

Correspondence Address: CHARLES E. BAXLEY, ESQ., 90 JOHN STREET, THIRD FLOOR, NEW YORK, NY, 10038, US

(21) Appl. No.: 11/644,919

(22) Filed: Dec. 22, 2006

(51) Int. Cl. G08G 1/16

(52) U.S. Cl. 340/903

(57) ABSTRACT

A vehicle distance warning device includes a signal emitting device and a signal receiving device coupled to a processing device for emitting and receiving distance detecting signals in order to detect the distance between the moving vehicles, the processing device may calculate the distance between the moving vehicles with the received signals and the distance may be indicated by the warning light device or a warning sound device in order to indicate whether the moving vehicles are moving too close to each other or not and for allowing the vehicle drivers to make the responding or suitable actions and to prevent car accidents from being occurred.

### BACKGROUND OF THE INVENTION

1. Field of the Invention

The present invention relates to a distance warning or indicating device for vehicle, and more particularly to a distance warning or indicating device for attaching to a vehicle and for indicating the distance between the moving vehicles and/or for warning the vehicle driver that the other moving vehicles are too close to his vehicle.

2. Description of the Prior Art

Typical vehicles may comprise a warning device indicating whether an object is too close to the vehicle or not when the vehicle is moving backwardly.

In some conditions, for example, in fog or raining days, or in smoke areas, the vehicle drivers may not clearly see the environment, and thus may not clearly know whether the other moving vehicles are too close to his vehicle or not, such that car accidents may easily occurred in these areas.

In addition, it will be safer to keep or maintain a suitable distance between two moving vehicles, and the suitable distance between two moving vehicles is greater when the moving vehicles are moving in greater speeds. However, while driving the vehicles, the vehicle drivers have no time to calculate the suitable distance between the two moving vehicles in correspondence to the changing speeds of the vehicles.

The present invention has arisen to mitigate and/or obviate the afore-described disadvantages of the conventional distance warning devices for vehicles.

### SUMMARY OF THE INVENTION

The primary objective of the present invention is to provide a distance warning device for attaching to a vehicle and for indicating the distance between the moving vehicles and/or for warning the vehicle driver that the other moving vehicles are too close to his vehicle.

In accordance with one aspect of the invention, there is provided a vehicle distance warning device comprising a processing device, a signal emitting device coupled to the processing device for emitting a distance detecting signal to detect a distance between moving vehicles, a signal receiving device coupled to the processing device for receiving signals and for sending the received signals to the processing device, the processing device calculating a distance between the moving vehicles with the received signals, a warning light device coupled to the processing device for indicating whether the moving vehicles are too close to each other or not, and a warning sound device coupled to the processing device for generating a warning sound to indicate that the vehicles are moving too close to each other.

A housing may further be provided for receiving the processing device, the signal emitting device, the signal receiving device, the warning light device, and the warning sound device. The warning light device includes at least one light member disposed on the housing. The housing includes one or more indicia provided beside the light members for indicating the distance represented by the light member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a block diagram illustrating the parts or elements of a distance warning device for vehicle in accordance with the present invention; and

FIG. 2 is a plan schematic view illustrating a housing of the distance warning device for vehicle.

### DETAILED DESCRIPTION OF THE PREFERRED EMBODIMENT

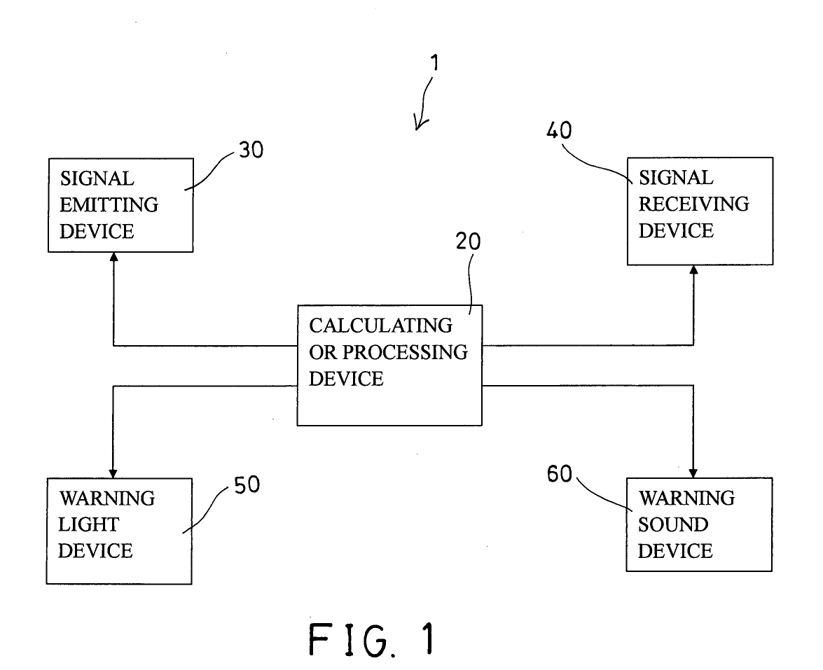

Referring to the drawings, and initially to FIG. 1, a distance warning device 1 in accordance with the present invention is provided for attaching to a vehicle (not shown) and for indicating the distance between the moving vehicles and/or for warning the vehicle driver that the other moving vehicles are too close to his vehicle. The distance warning device 1 comprises a calculating or processing device 20 for data calculating or processing purposes, a signal emitting device 30 coupled to the processing device 20 for being actuated or operated by the processing device 20 to emit the distance detecting signals, such as the infrared rays, laser beams, radio waves, etc., and to detect the distance between the moving vehicles.

The distance warning device 1 further comprises a signal receiving device 40 also coupled to the processing device 20 for receiving the distance detecting signals emitted from the signal emitting device 30 and/or returning from the other moving vehicles and/or transmitted backwardly from the other moving vehicles, and for sending the received signals to the processing device 20. When or after receiving the distance detecting signals emitted from the signal emitting device 30 and/or received by the signal receiving device 40, the processing device 20 may calculate the distance between the moving vehicles and/or may calculate the required or the suitable distance between the moving vehicles, particularly in correspondence to the changing or varying speeds of the moving vehicles.

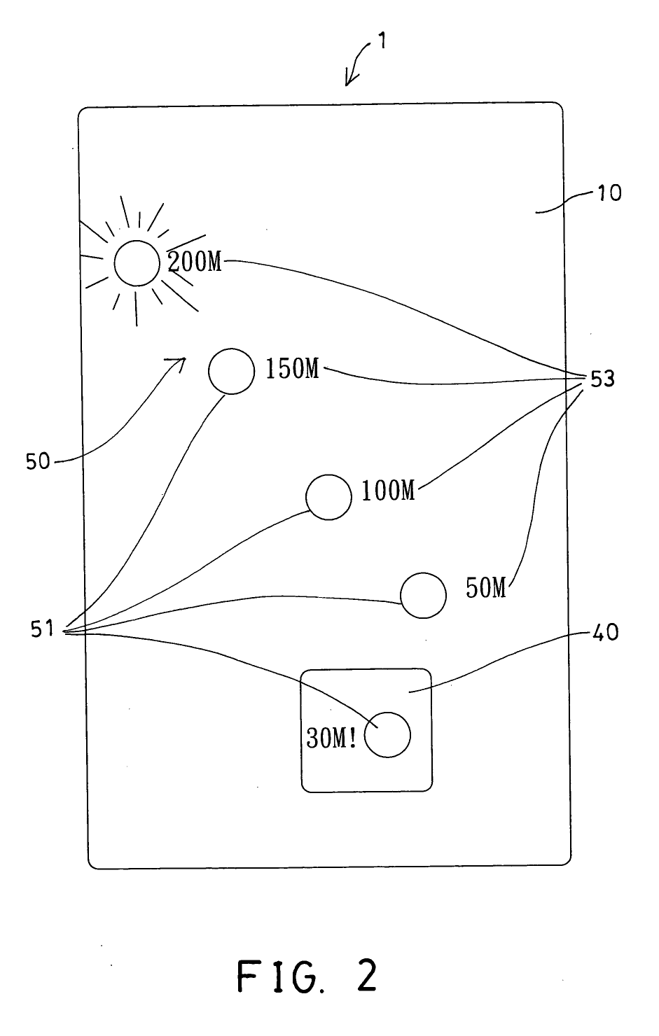

A warning light device 50 may further be provided and coupled to the processing device 20 for indicating whether the other moving vehicles are too close to the vehicle or not, and/or for indicating the distance between the moving vehicles. For example, as shown in FIG. 2, the warning light device 50 may include one or more light members 51, such as light emitting diodes, liquid crystal displays, etc., for indicating or representing different distances respectively and thus for indicating the corresponding distances between the moving vehicles and for allowing the vehicle drivers to make the responding actions, particularly when the other moving vehicles are too close to the vehicle driver's vehicle.

A warning sound device 60 may further be provided and coupled to the processing device 20 for generating a warning sound to indicate that the moving vehicles are moving too close to each other, and/or for indicating whether the other moving vehicles are moving too close to the vehicle or not, and/or for telling and warning the vehicle driver that the other moving vehicles are moving too close to the vehicle, and/or for telling and indicating the distance between the moving vehicles. As shown in FIG. 2, the distance warning device 1 may include a housing 10 for receiving the processing device 20, the signal emitting device 30, the signal receiving device 40, the warning light device 50, and the warning sound device 60, and may include one or more indicia or marks or words 53 provided beside the corresponding light members 51 for suitably indicating the corresponding distances between the moving vehicles. The light members 51 of the warning light device 50 are disposed on the outer or upper portion of the housing 10.

In operation, when the other moving vehicles are too close to the vehicle driver's vehicle, the warning light device 50 may be used to indicate the corresponding distances between the moving vehicles and/or to indicate whether the other moving vehicles are too close to the vehicle driver's vehicle or not, for allowing the vehicle drivers to make the responding actions and for preventing the car accidents from being occurred. In addition or alternatively, the warning light device 60 may also be used to indicate the corresponding distances between the moving vehicles and/or to indicate whether the other moving vehicles are too close to the vehicle driver's vehicle or not.

It is preferable that the processing device 20 may include a corresponding data or information stored therein that indicates or represents the safe or required or suitable distance between the moving vehicles at different moving speeds. The processing device 20 may compare the signals received or calculated from the signal emitting device 30 and the signal receiving device 40 in order to suitably indicate the safe or required or suitable distance between the moving vehicles at different moving speeds.

Accordingly, the distance warning device in accordance with the present invention may be provided for attaching to a vehicle and for indicating the distance between the moving vehicles and/or for warning the vehicle driver that the other moving vehicles are too close to his vehicle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A vehicle distance warning device comprising:
a processing device,
a signal emitting device coupled to said processing device for emitting a distance detecting signal to detect a distance between moving vehicles,
a signal receiving device coupled to said processing device for receiving signals and for sending the received signals to said processing device, said processing device calculating a distance between the moving vehicles with the received signals,
a warning light device coupled to said processing device for indicating whether the moving vehicles are too close to each other or not, and
a warning sound device coupled to said processing device for generating a warning sound to indicate that the vehicles are moving too close to each other.

2. The distance warning device for vehicle as claimed in claim 1 further comprising a housing for receiving said processing device, said signal emitting device, said signal receiving device, said warning light device, and said warning sound device.

3. The distance warning device for vehicle as claimed in claim 2, wherein said warning light device includes at least one light member disposed on said housing.

4. The distance warning device for vehicle as claimed in claim 3, wherein said housing includes an indicium provided beside said at least one light member.
